(19) United States
(12) Patent Application Publication
(10) Pub. No.: US 2014/0079023 A1
(43) Pub. Date: Mar. 20, 2014

(54) Method of Internet Protocol (IP) to IP handover

(71) Applicant: D2 Technologies Inc., Santa Barbara, CA (US)

(72) Inventors: David Lindsay, Santa Barbara, CA (US); Steve Parrish, Algonquin, IL (US); Matthew Randmaa, Santa Barbara, CA (US)

(73) Assignee: D2 Technologies Inc., Santa Barbara, CA (US)

(21) Appl. No.: 14/027,239

(22) Filed: Sep. 15, 2013

Related U.S. Application Data
(60) Provisional application No. 61/703,268, filed on Sep. 20, 2012.

(51) Int. Cl. H04W 36/00

(52) U.S. Cl. CPC H04W 36/0011
USPC 370/331

(57) ABSTRACT

Methods of IP to IP handover for VoIP calls are disclosed. Handover can occur using UDP in connectionless mode to switch networks, a hybrid approach including establishing both a TCP session and a UDP session and handing off using the UDP session, utilizing a network SIP proxy to maintain connection with the IMS server while the mobile device switches networks connecting the mobile device to the SIP proxy, using a modified Connection Manager that permits multiple IP connections simultaneously, and connecting via an on-device virtual network to an on-device router which reroutes calls to the appropriate network are detailed.

### CROSS REFERENCE TO RELATED APPLICATIONS

This application claims the benefit of U.S. Provisional Patent Application Ser. No. 61/703,268 filed Sep. 20, 2012 and included herein by reference for all intents and purposes.

### BACKGROUND OF THE INVENTION

1. Field of the Invention

This document is generally related to the IP to IP handover problems in a mobile device and specifically related to solutions to the IP to IP handover problems for SIP signaling using either UDP or TCP as the signaling transport.

2. Description of the Prior Art

Cell phone networks have techniques for handing off a voice call from one cell tower to another without disruption in the voice call. As Voice over Internet Protocol (VoIP) is added to cell phones, a similar goal called voice call continuity (VCC) is required. VCC provides continuity in the voice signal as a call is handed off from the legacy cell network to the Internet Protocol (IP) network and vice versa.

As mobile operators move more traffic from the legacy network to IP networks, a new problem arises. There is now a need to switch VoIP calls between a mobile IP network and other IP networks, such as Wi-Fi™ hotspots, without losing the call. This document describes different methods for solving this problem.

VoIP calls are managed by the Session Initiation Protocol (SIP). SIP uses a layer three protocol, either User Datagram Protocol (UDP) or Transmission Control Protocol (TCP), to transport signaling. Major mobile phone operating systems do not allow an application to keep open UDP ports. There are a number of reasons for this restriction, such as device security. Consequently, a mobile device cannot be certified by Google if applications are allowed to maintain open UDP ports. Apple also does not accept such applications.

This means that the applications that utilize SIP service must use TCP for transport signaling. TCP transport is connection based. When the connection is broken (e.g. Wi-Fi™ hotspot moves out of range), the TCP connection is terminated. This will terminate any active calls.

Another constraint comes from the Connection Manager of popular operating systems for mobile devices, such as Android. The algorithm used by the Connection Manager disconnects a lower priority network when a higher priority network becomes available. A typical mobile phone accesses the IP network using either the mobile cellular data network interface or the Wi-Fi™ network interface. If the application is using the mobile cellular data network, IP connections will be dropped as soon as a Wi-Fi™ network becomes available. This is not a problem for many data applications like web browsing or email, but it is a serious problem for a voice call.

A known approach to supporting handover is to use virtual private network (VPN) tunnels. The edge router on the service provider's core network can supply VPN to the mobile device. There is a proposed standard to modify the standard VPN protocol to speed up tunnel setup. This would reduce the delay from several seconds to less than a second when switching from one network to another.

With the VPN connection, the mobile device maintains the same IP address when roaming from network to network. The edge router maintains connections while the VPN tunnel is moved. If the VPN application on the client maintains the VoIP application's connection during the network interface change, the handover could be performed without affecting the VoIP application.

However VPN tunnels have some downsides. There is a significant delay to create the VPN tunnel. In addition, each packet experiences some encryption delay. Part of this delay is caused by the need to accumulate enough data for encryption to be effective. If not enough data is accumulated, unauthorized decryption is significantly easier. If the device has hardware support, some of the encryption delay can be minimized. However, the current generation of phones does not have such hardware support.

Another known approach is Internet Protocol version 6 (IPv6) Roaming. Request for Comments (RFC) 6275 describes how IPv6 can support roaming with a mobile device. The device is associated with a home network. This is the network that gives the device its IP address. There is a router on the home network that is responsible for routing traffic to the mobile device. When the device is on the home network, it works like a traditional router. When the device leaves its home network, the mobile device tells the home router where it is located (and a network route is determined), and creates a VPN connection to the home network. It uses this connection for all IP traffic. When the mobile device registers with the IMS server, it is always done through the home router. So as long as the mobile device maintains its VPN connection with the home router, the IMS server can maintain sessions with the mobile device as it roams from one mobile network to another.

This roaming approach has a couple of disadvantages. First, the latency of the call is increased because all incoming packets must first be sent to the home router then sent back out to the device. Even if the home router is inside the service provider's network, a device's home router may be on one coast of a nationwide service provider's network while the device is roaming on another coast. In addition to delay, this approach doubles the coast-to-coast traffic on the service provider's network. Another issue is that all of the traffic from the device is routed this way. For example, when a web page is accessed from the device, the web traffic is going to be routed the same way. This type of roaming is inefficient and unnecessary for most web applications. Since this method uses VPN to connect to the home network, it also has all of the disadvantages of VPN approach for VoIP calls.

### SUMMARY OF THE INVENTION

A method of Internet Protocol (IP) to IP handover is disclosed that includes a mobile device forming a cellular data connection to a first cellular data network, registering the mobile device with an Internet Protocol Multimedia Subsystem (IMS) server using the first cellular data network by means of User Datagram Protocol (UDP) in connectionless mode. The mobile device places or receives a Voice over IP (VoIP) call using the first cellular data network and begins streaming voice data after the VoIP call is connected. When a first Wi-Fi™ network comes into range, the mobile device drops the connection to the first cellular data network, establishes an IP connection using the first Wi-Fi™ network, registers with the IMS server using the first Wi-Fi™ network, and uses a Session Initiation Protocol (SIP) REINVITE method to transfer the VoIP call to a new IP address obtained when the mobile device switched to the first Wi-Fi™ network. Methods are also proposed for a similar switch of IP connections from a first Wi-Fi™ network to a second Wi-Fi™ network, and from a first Wi-Fi™ network to a cellular data network.

Another method of Internet Protocol (IP) to IP handover is disclosed that includes a mobile device forming a connection to a cellular data network and creating a first registration with an Internet Protocol Multimedia Subsystem (IMS) server using the cellular data network by means of Transmission Control Protocol (TCP) transport for Session Initiation Protocol (SIP) signaling, establishing a TCP session. The mobile device places or receives a Voice over IP (VoIP) call using the cellular data network and starts streaming voice data after the VoIP call is connected. The mobile device creates a second registration with the IMS server using User Datagram Protocol (UDP) signaling establishing a UDP session. After the mobile device is registered with the IMS server on both TCP and UDP, the mobile device sends a REINVITE message to move the call from the TCP session to the UDP session without a switch of IP addresses. The UDP session can then be used to switch IP connections to a different network, such as from the cellular data network to a Wi-Fi™ network. Methods are also proposed for a similar switch of IP connections from a first Wi-Fi™ network to a second Wi-Fi™ network, and from a first Wi-Fi™ network to a cellular data network.

Another method of Internet Protocol (IP) to IP handover is disclosed that includes a mobile device forming a cellular data connection to a Session Initiation Protocol (SIP) Proxy to connect to a cellular data network using Transmission Control Protocol (TCP). The mobile device registers with an Internet Protocol Multimedia Subsystem (IMS) server using the SIP Proxy of the cellular data network and places or receives a Voice over IP (VoIP) call using the SIP Proxy and the mobile device streams voice data after the VoIP call is connected. When a Wi-Fi™ network comes into range, the mobile device drops the cellular data connection to the SIP Proxy and established an IP connection using the Wi-Fi™ network. The mobile device registers with the SIP Proxy server using the Wi-Fi™ network, and uses a SIP REINVITE method to transfer the VoIP call to a new IP address obtained when the mobile device switched to the Wi-Fi™ network. Methods are also proposed for a similar switch of IP connections from a first Wi-Fi™ network to a second Wi-Fi™ network, and from a first Wi-Fi™ network to a cellular data network.

Another method of Internet Protocol (IP) to IP handover that discloses a mobile device forming a cellular data connection to a cellular data network and registering the mobile device with an Internet Protocol Multimedia Subsystem (IMS) server using the cellular data network by means of Transmission Control Protocol (TCP) transport for Session Initiation Protocol (SIP) signaling. The mobile device places or receives a Voice over IP (VoIP) call using the cellular data network and begins streaming voice data after the VoIP call is connected. A Connection Manager of the mobile device signals a Session Initiation Protocol (SIP) application of the mobile device that a Wi-Fi™ connection is available and the mobile device establishes an IP connection using the Wi-Fi™ network while maintaining the cellular data connection to the cellular data network. The mobile device registers with the IMS server using the Wi-Fi™ network and uses a SIP REINVITE method to transfer the VoIP call to a first new IP address obtained when the mobile device switched to the Wi-Fi™ network. After the VoIP call is transferred to the first new IP address, the mobile device disconnecting from the cellular data network. Methods are also proposed for a similar switch of IP connections from a first Wi-Fi™ network to a second Wi-Fi™ network, and from a first Wi-Fi™ network to a cellular data network.

Another method of Internet Protocol (IP) to IP handover is disclosed that includes a Session Initiation Protocol (SIP) application of a mobile device connecting to a port of a virtual network on the mobile device. A router on the mobile device routes registration of the mobile device with an IP Multimedia Core Network Subsystem (IMS) server from the virtual network to a cellular data network using Transmission Control Protocol (TCP). The mobile device places or receives a Voice over IP (VoIP) call using the cellular data network starts streaming voice data after the VoIP call is connected. A Connection Manager of the mobile device disconnects the mobile device from the cellular data network when a Wi-Fi™ network comes into range and establishes an IP connection to the Wi-Fi™ network. The router switches the VoIP call from the cellular data network to the Wi-Fi™ network. Methods are also proposed for a similar switch of IP connections using the router from a first Wi-Fi™ network to a second Wi-Fi™ network, and from a first Wi-Fi™ network to a cellular data network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart for IP to IP handover using UDP signaling according to one embodiment.

FIG. 2 is detailed sequence diagram illustrating IP to IP handover using UDP signaling according to one embodiment.

FIG. 3 is a flow chart for IP to IP handover using Hybrid TCP/UDP signaling according to one embodiment.

FIG. 4 is detailed sequence diagram illustrating IP to IP handover where the SIP TCP connection is terminated when cellular data transmission is disabled by the Connection Manager of the mobile device.

FIG. 5 is a flow chart for IP to IP handover using TCP Signaling via a SIP TCP Proxy according to one embodiment.

FIG. 6 is detailed sequence diagram illustrating IP to IP handover using TCP Signaling via a SIP TCP Proxy according to one embodiment.

FIG. 7 is a flow chart for IP to IP TCP handover using a Modified Connection Manager according to one embodiment.

FIG. 8 is detailed sequence diagram illustrating IP to IP TCP handover using a Modified Connection Manager according to one embodiment.

FIG. 9 is a flow chart for IP to IP handover using an on-device router according to one embodiment.

FIG. 10 is a block diagram illustrating the use of a virtual network when using the on-device router according to one embodiment.

### DETAILED DESCRIPTION

Within this document and claims, the term “network” is defined as a point of interconnection between a mobile terminal and a private or public network. Therefore, when switching from a first network to a second network or a different network, the IP address of the mobile device also changes. Examples of a network include, inter alia, Wi-Fi™ technologies and cellular technologies. Throughout this document and claims, particular technologies are presented as specific examples of use; however, in all cases the description of a particular technology does not limit the claims to only that technology, but is intended to be generalized as described above. For example, a discussion of a trademarked technology, such as, inter alia, Wi-Fi™, should be considered a discussion of any and/or all versions of similar technology, rather than the specific technology or the source of the technology. Similarly, when a particular version or portion of a mobile operating system is referenced, it is intended to be generalized to include all versions or portions of a mobile operating system that perform similar functionality. For example, when a term similar to Android Connection Manager is used, the Connection Manager is not limited to being of an Android version, but may be a different kind of Connection Manager used with a mobile operating system.

Handover using UDP Signaling

A first proposed solution to the IP to IP handover problem is the use of UDP protocol for transport. Although this solution does not meet all of the constraints of the mobile OS, it is a solution to the handover problem.

When UDP is used to transport data, the application has an option to use the protocol in the connectionless mode. When in the connectionless mode, there is no support in the UDP protocol that lets each side know that the other side is still connected. Each side sends UDP packets with the hope that the other side receives them, but reception is not guaranteed. This is referred to as “best effort signaling”. In this case, a higher level protocol, SIP, handles the cases where packets are dropped by the network or the other party has been disconnected from the network. SIP uses redundant transmissions and various timeouts to handle dropped packets and disconnection.

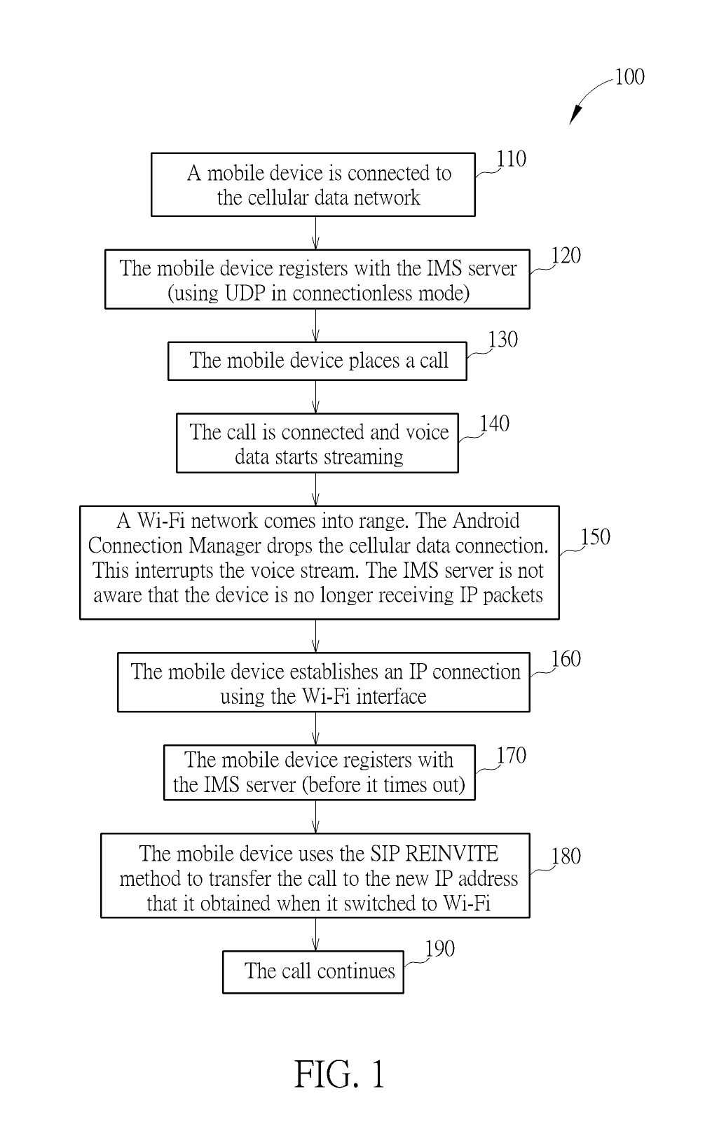

One approach to IP to IP handover is to maintain the state of the call in the IMS network for a short period of time when the mobile device is temporarily disconnected from the network. This would allow a device that quickly recovers connectivity to re-establish the audio stream using the same SIP session. Please refer to FIG. 1 which illustrates a possible sequence 100 of events demonstrating this approach.

Step 110: A mobile device is connected to the cellular data network.

Step 120: The mobile device registers with the IMS server (using UDP in connectionless mode.)

Step 130: The mobile device places a call.

Step 140: The call is connected and voice data starts streaming.

Step 150: A Wi-Fi™ network comes into range. The Android Connection Manager drops the cellular data connection. This interrupts the voice stream. The IMS server is not aware that the device is no longer receiving IP packets.

Step 160: The mobile device establishes an IP connection using the Wi-Fi™ interface.

Step 170: The mobile device registers with the IMS server (before it times out.)

Step 180: The mobile device uses the SIP REINVITE method to transfer the call to the new IP address that it obtained when it switched to Wi-Fi.

Step 190: The call continues.

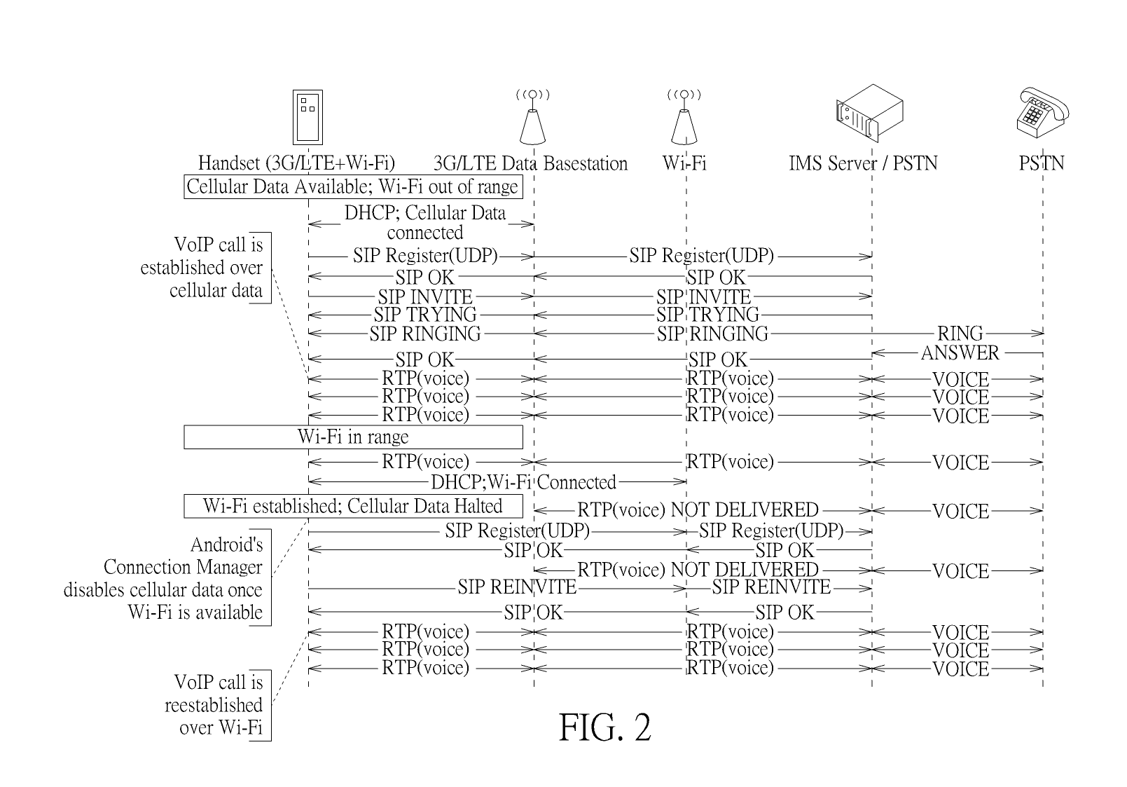

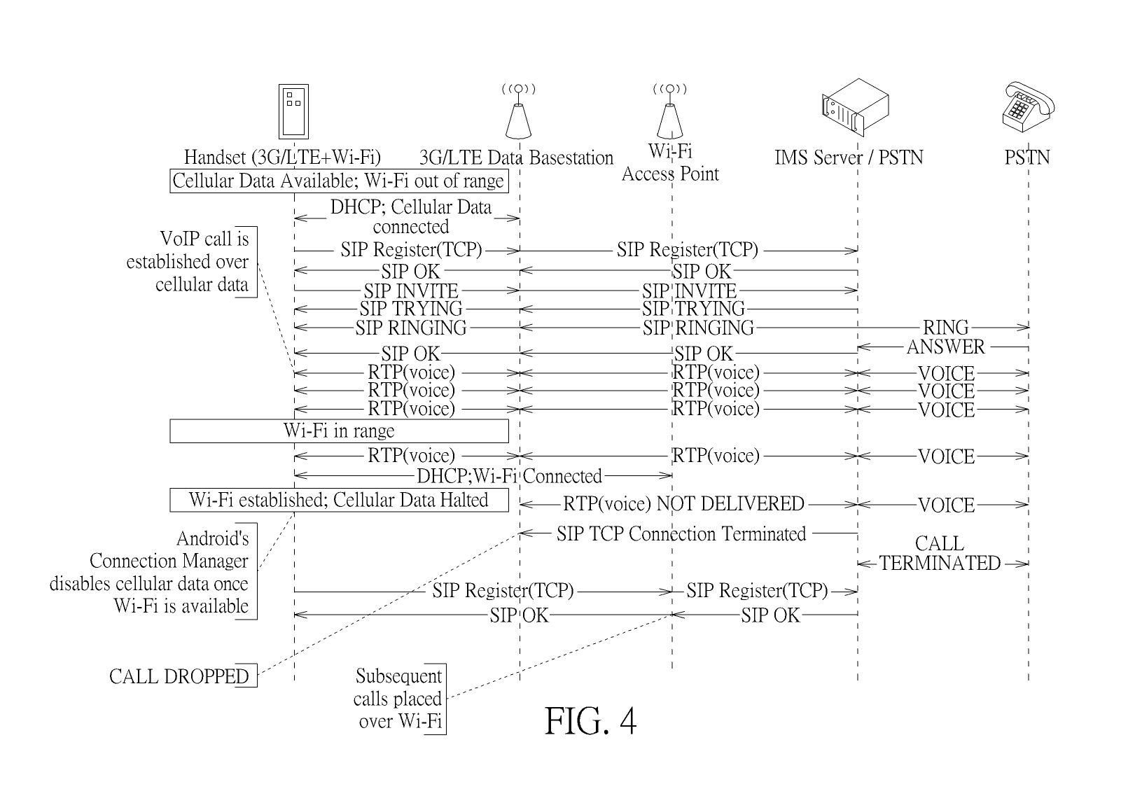

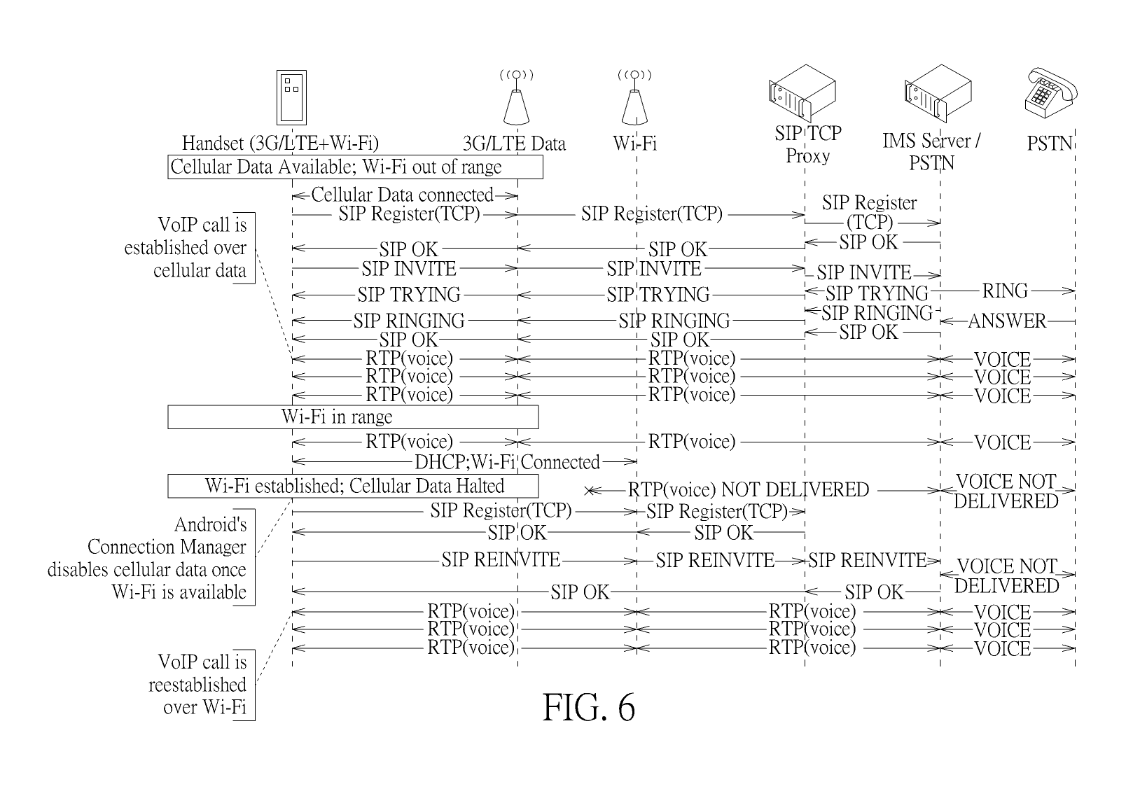

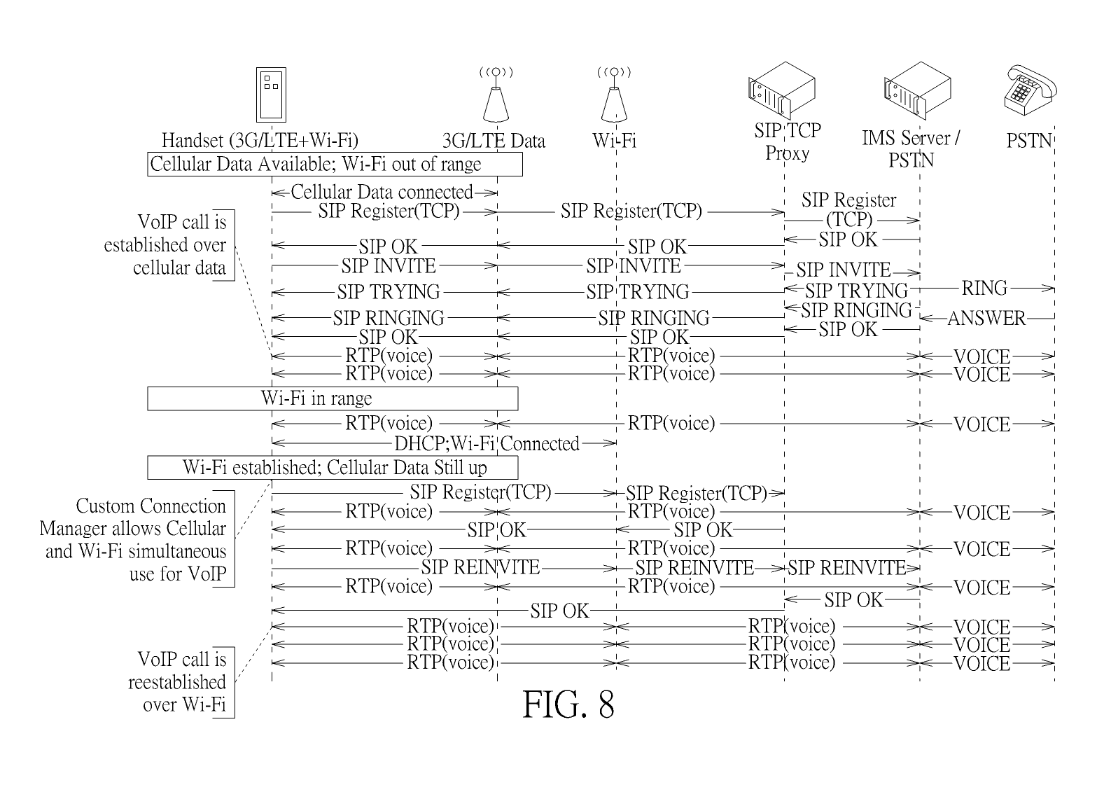

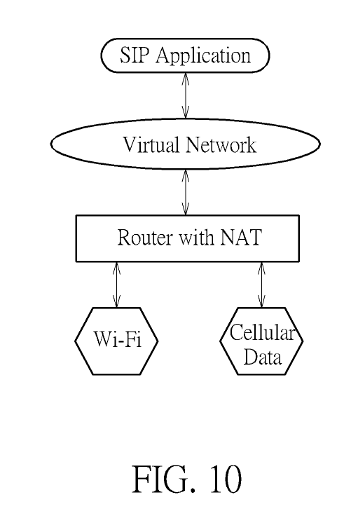

FIG. 2 is detailed sequence diagram illustrating these steps. The following additional terms used in FIG. 2, as well as FIG. 4, FIG. 6, and FIG. 8 are defined as follows. 3G is short for the 3rd Generation cellular technology. LTE is short for Long Term Evolution cellular technology. PSTN is short for public switched telephone network. DHCP is short for Dynamic Host Configuration Protocol. RTP is short for Real-time Transport Protocol. In FIG. 10, NAT is short for Network Address Translation.

When using the disclosed handover using UDP signaling solution to the IP to IP handover problem, although the steps shown in FIG. 1 and FIG. 2 remain approximately the same, the specific networks identified may be different than disclosed without departing from the scope of the claims. For example, in step 110, the mobile device may be connected to a first Wi-Fi™ network, in step 150 a different Wi-Fi™ network comes into range to which the mobile device connects in step 160. Another possible example would include switching connections of the mobile device from a Wi-Fi™ network to a cellular data network using a similar procedure. Furthermore, the Connection Manager is not limited to being of an Android version, but may be a different kind of Connection Manager used with a mobile operating system.

Hybrid TCP/UDP Signaling

This section describes an approach to solving the IP to IP handover that addresses the mobile OS constraint issue (of not allowing open UDP ports) not addressed in the UDP handover approach described in the previous section. This hybrid approach requires that the IMS server is able to support both a TCP and UDP registration from the device simultaneously.

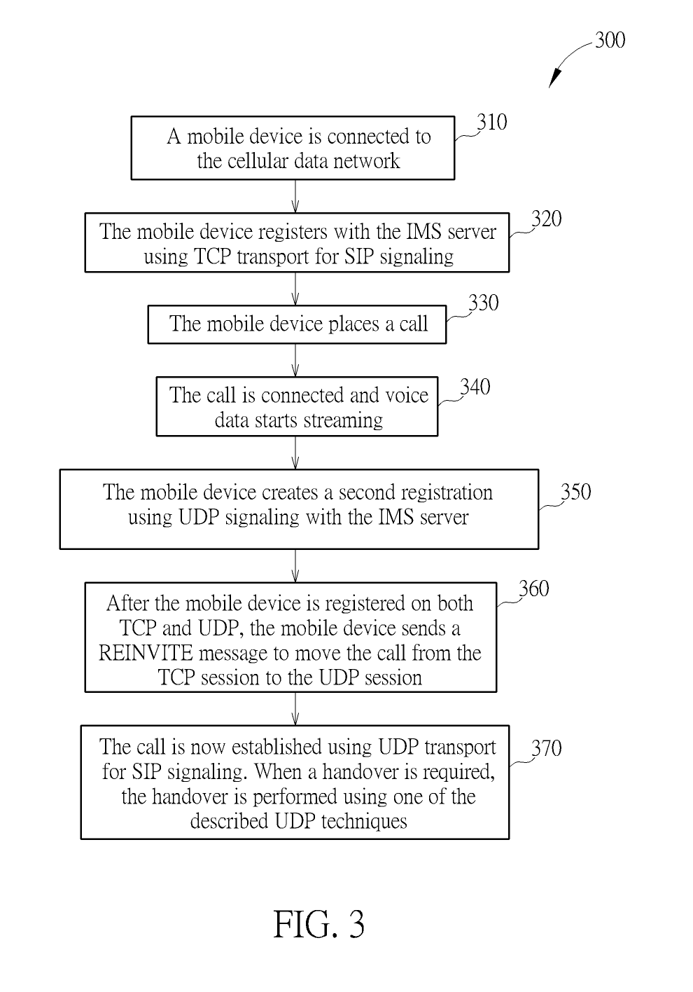

The device substantially permanently registers with the IM server using TCP for SIP signaling. This is the registration that the IMS server uses for initiating new sessions and managing non-VoIP sessions. The mobile device does not need to keep a UDP port open all of the time, and meets the constraints of the Mobile operating system. Whenever a call is established and active, a second temporary registration is created using UDP for SIP signaling. Please refer to FIG. 3 which illustrates a possible sequence 300 of events demonstrating this hybrid approach.

Step 310: A mobile device is connected to the cellular data network.

Step 320: The mobile device registers with the IMS server using TCP transport for SIP signaling.

Step 330: The mobile device places a call.

Step 340: The call is connected and voice data starts streaming.

Step 350: The mobile device creates a second registration using UDP signaling with the IMS server.

Step 360: After the mobile device is registered on both TCP and UDP, the mobile device sends a REINVITE message to move the call from the TCP session to the UDP session.

Step 370: The call is now established using UDP transport for SIP signaling. When a handover is required, the handover can be performed using one of the described UDP techniques, for example, example a variation of sequence 100 illustrated in FIG. 1, although other UDP techniques are also possible.

When using the disclosed hybrid TCP/UDP signaling solution to the IP to IP handover problem shown in FIG. 3, again although the steps shown remain approximately the same, the specific networks identified may be different than disclosed without departing from the scope of the claims. For example, in step 310, the mobile device may be connected to a Wi-Fi™ network.

Handover using TCP Signaling via a SIP TCP Proxy

When SIP uses TCP for the data transport, the IP to IP handover problem cannot be solved the same way as was described above for UDP. Because TCP enforces a connection between endpoints, the IMS server knows when it loses connection with the mobile device. When the IMS server detects the loss of connection, the IMS server terminates the call. This is illustrated in the flow diagram shown in FIG. 4 where the SIP TCP connection is terminated when cellular data transmission is disabled by the Connection Manager of the mobile device.

An approach to solving this problem is to add a SIP TCP proxy into the network. The role of this proxy is to anchor a connection with the IMS server while giving the mobile device a chance to switch IP interfaces and register.

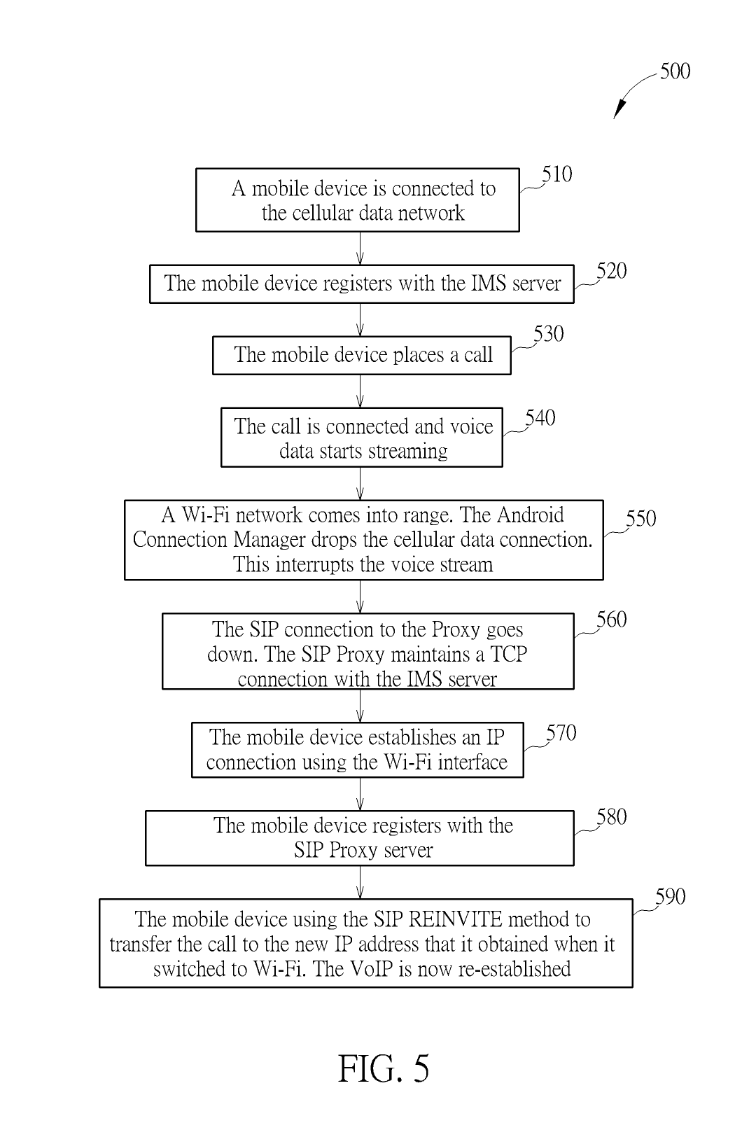

FIG. 5 shows a sequence of actions 500 that can be used demonstrate this approach.

Step 510: A mobile device is connected to a SIP TCP proxy in the cellular data network.

Step 520: The mobile device registers with the IMS server.

Step 530: The mobile device places a call.

Step 540: The call is connected and voice data starts streaming.

Step 550: A Wi-Fi™ network comes into range. The Android Connection Manager drops the cellular data connection. This interrupts the voice stream.

Step 560: The SIP connection to the Proxy goes down. The SIP TCP Proxy maintains a TCP connection with the IMS server.

Step 570: The mobile device establishes an IP connection using the Wi-Fi™ interface.

Step 580: The mobile device registers with the SIP Proxy server.

Step 590: The mobile device using the SIP REINVITE method to transfers the call to the new IP address that it obtained when it switched to Wi-Fi. The VoIP is now re-established.

FIG. 6 is a detailed sequence diagram illustrating the sequence of actions 500.

When using the disclosed network SIP TCP proxy solution to the IP to IP handover problem, although the steps shown in FIG. 5 and FIG. 6 remain approximately the same, the specific networks identified may be different than disclosed without departing from the scope of the claims. For example, in step 510, the mobile device may be connected to a first Wi-Fi™ network, in step 550 a different Wi-Fi™ network comes into range to which the mobile device connects in step 570. Another possible example would include switching connections of the mobile device from a Wi-Fi™ network to a cellular data network using a similar procedure. Furthermore, the Connection Manager is not limited to being of an Android version, but may be a different kind of Connection Manager used with a mobile operating system.

TCP Handover using a Modified Connection Manager

The standard Android Connection Manager only allows one IP interface to be active at a time. Because of this limitation, the VoIP voice connection is dropped when the Connection Manager disconnects from one network before it establishes a new connections when it switches networks. This problem is referred to as “break before make”.

If the Android Connection Manager can be replaced with a Modified Connection Manager which allows two network interfaces to be active during the handover from one network to the other, then a voice call can be switched to the new network before the old network is disconnected. This is often referred to in VCC as “make before break”.

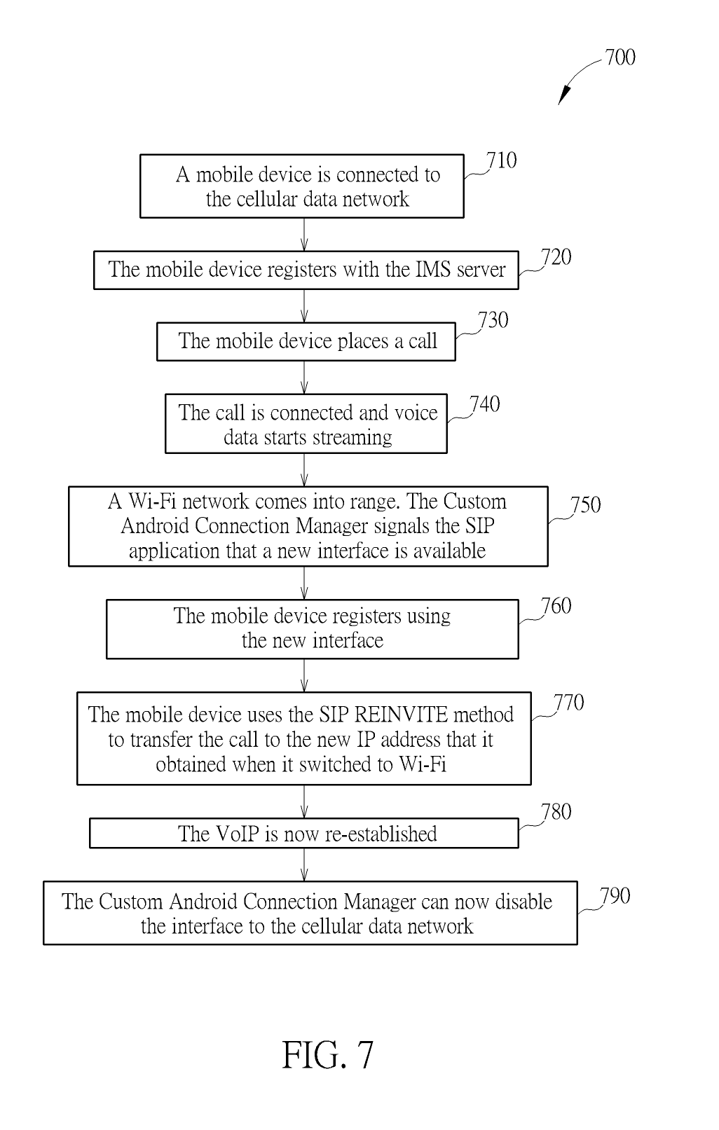

FIG. 7 shows a sequence of actions 700 that can be used demonstrate this approach.

Step 710: A mobile device is connected to the cellular data network.

Step 720: The mobile device registers with the IMS server.

Step 730: The mobile device places a call.

Step 740: The call is connected and voice data starts streaming.

Step 750: A Wi-Fi™ network comes into range. The Custom Android Connection Manager signals the SIP application that a new interface is available.

Step 760: The mobile device registers using the new interface.

Step 770: The mobile device uses the SIP REINVITE method to transfer the call to the new IP address that it obtained when it switched to Wi-Fi.

Step 780: The VoIP is now re-established.

Step 790: The Custom Android Connection Manager can now disable the interface to the cellular data network.

FIG. 8 is a detailed sequence diagram illustrating steps 710-790.

When using the disclosed handover using a modified Connection Manager as solution to the IP to IP handover problem, although the steps shown in FIG. 7 and FIG. 8 remain approximately the same, the specific networks identified may be different than disclosed without departing from the scope of the claims. For example, in step 710, the mobile device may be connected to a first Wi-Fi™ network, in step 750 a different Wi-Fi™ network comes into range to which the mobile device connects in step 760. Another possible example would include switching connections of the mobile device from a Wi-Fi™ network to a cellular data network using a similar procedure. Furthermore, the Connection Manager is not limited to being of an Android version, but may be a different kind of Connection Manager used with a mobile operating system that permits multiple IP interfaces to be active at any one time.

On-Device Router

One of the characteristics of IP networks is that the network path between two devices can change dynamically without the devices losing connection.

Linux devices like Android phones are capable of serving as routers. If the device acts as a router supporting a virtual network on the device, it is possible to take advantage of the re-routing capabilities of IP communications to support IP handover of voice calls.

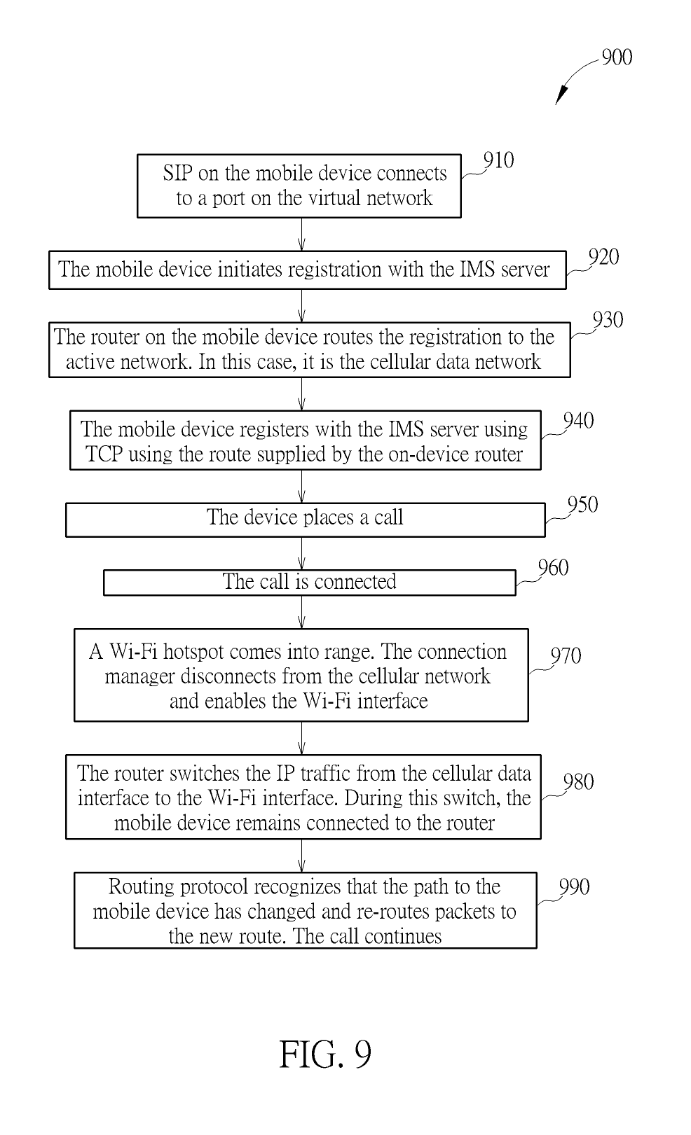

FIG. 9 shows how a mobile device can solve the handover problem using a router on the mobile device using event sequent 900.

Step 910: The SIP on the mobile device connects to a port on a virtual network within the mobile device to the router on the mobile device.

Step 920: The mobile device initiates registration with the IMS server via the virtual network and the router.

Step 930: The router on the mobile device routes the registration to the active network. In this case, it is the cellular data network.

Step 940: The mobile device registers with the IMS server using TCP using the route supplied by the on-device router.

Step 950: The mobile device places a call.

Step 960: The call is connected.

Step 970: A Wi-Fi™ hotspot comes into range. The Connection Manager of the mobile device disconnects from the cellular network and enables the Wi-Fi™ interface.

Step 980: The router switches the IP traffic from the cellular data interface to the Wi-Fi™ interface. During this switch, the mobile device remains connected to the router via the virtual network.

Step 990: Routing protocol recognizes that the path to the mobile device has changed and re-routes packets to the new route. The call continues.

In order for steps 910-990 to work, two conditions must be satisfied. First, switching between networks must be faster than TCP timeouts. Second, the SIP application listens on ports on the virtual network. That port has an address on the virtual network. When the cellular data network is the preferred network, the router simply routes the data to the cellular data network. When the Wi-Fi™ network is the preferred network, the router then routes the data to the Wi-Fi™ network.

Handover occurs when the route is changed from one interface to another. This is somewhat similar to a node in the core network failing and the route changes to accommodate the failed node.

FIG. 10 is a functional block diagram of using the on-device router to switch networks during a VoIP call. The router preferably would include network address translation capabilities to isolate the addresses on the virtual network from the external networks.

When using the disclosed handover using an on-device router as a solution to the IP to IP handover problem, although steps shown in FIG. 9 remain approximately the same, the specific networks identified may be different than disclosed without departing from the scope of the claims. For example, in step 930, the mobile device may be connected to a first Wi-Fi™ network, in step 970 a different Wi-Fi™ network comes into range to which the mobile device connects in step 980. Another possible example would include switching connections of the mobile device from a Wi-Fi™ network to a cellular data network using a similar procedure.

### SUMMARY

This document describes several techniques for solving the IP to IP handover problem. Solutions are described for both SIP signaling using either UDP or TCP as the signaling transport.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of Internet Protocol (IP) to IP handover, the method comprising:
a mobile device forming a cellular data connection to a first cellular data network;
registering the mobile device with an Internet Protocol Multimedia Subsystem (IMS) server using the first cellular data network by means of User Datagram Protocol (UDP) in connectionless mode;
the mobile device placing or receiving a Voice over IP (VoIP) call using the first cellular data network;
the mobile device streaming voice data after the VoIP call is connected;
the mobile device dropping the connection to the first cellular data network when a first Wi-Fi™ network comes into range;
the mobile device establishing an IP connection using the first Wi-Fi™ network;
the mobile device registering with the IMS server using the first Wi-Fi™ network; and
the mobile device using a Session Initiation Protocol (SIP) REINVITE method to transfer the VoIP call to a new IP address obtained when the mobile device switched to the first Wi-Fi™ network.

2. The method of claim 1 further comprising:
the mobile device dropping the connection to the first Wi-Fi™ network when a second Wi-Fi™ network is determined to be in range;
the mobile device establishing an IP connection to the second Wi-Fi™ network;
the mobile device registering with the IMS server using the second Wi-Fi™ network; and
the mobile device using a Session Initiation Protocol (SIP) REINVITE method to transfer the VoIP call to a new IP address obtained when the mobile device switched to the second Wi-Fi™ network;
wherein the first Wi-Fi™ network is different than the second Wi-Fi™ network.

3. The method of claim 1 further comprising:
the mobile device dropping the connection to the first Wi-Fi™ network;
the mobile device establishing an IP connection to a second cellular data network;
the mobile device registering with the IMS server using the second cellular network; and
the mobile device using a Session Initiation Protocol (SIP) REINVITE method to transfer the VoIP call to a new IP address obtained when the mobile device switched to the second cellular network.

4. A method of Internet Protocol (IP) to IP handover, the method comprising:
a mobile device forming a connection to a cellular data network;
the mobile device creating a first registration with an Internet Protocol Multimedia Subsystem (IMS) server using the cellular data network by means of Transmission Control Protocol (TCP) transport for Session Initiation Protocol (SIP) signaling, establishing a TCP session;
the mobile device placing or receiving a Voice over IP (VoIP) call using the cellular data network;
the mobile device streaming voice data after the VoIP call is connected;
the mobile device creating a second registration with the IMS server using User Datagram Protocol (UDP) signaling, establishing a UDP session; and
after the mobile device is registered with the IMS server on both TCP and UDP, the mobile device sending a REINVITE message to move the call from the TCP session to the UDP session without a switch of IP addresses.

5. The method of claim 4 further comprising:
a Connection Manager of the mobile device dropping the connection to the cellular data network when the Connection Manager determines a Wi-Fi™ network becomes available;
the mobile device establishing an IP connection using the Wi-Fi™ network to obtain a new IP address;
the mobile device registering with the IMS server using the Wi-Fi™ network by means of UDP in connectionless mode;
the mobile device using a Session Initiation Protocol (SIP) REINVITE method to transfer the VoIP call to the new IP address obtained when the mobile device switched to the Wi-Fi™ network; and
the mobile device streaming voice data of the VoIP call using the Wi-Fi™ network.

6. The method of claim 5 further comprising:
a Connection Manager of the mobile device dropping the connection to the Wi-Fi™ network when the Connection Manager determines a different Wi-Fi™ network becomes available;
the mobile device establishing an IP connection using the different Wi-Fi™ network to obtain a new IP address;
the mobile device registering with the IMS server using the different Wi-Fi™ network by means of UDP in connectionless mode;
the mobile device using a Session Initiation Protocol (SIP) REINVITE method to transfer the VoIP call to the new IP address obtained when the mobile device switched to the different Wi-Fi™ network; and
the mobile device streaming voice data of the VoIP call using the different Wi-Fi™ network.

7. The method of claim 5 further comprising:
a Connection Manager of the mobile device dropping the connection to the Wi-Fi™ network;
the mobile device establishing an IP connection using the cellular data network to obtain a new IP address;
the mobile device registering with the IMS server using the cellular data network by means of UDP in connectionless mode;
the mobile device using a Session Initiation Protocol (SIP) REINVITE method to transfer the VoIP call to the new IP address obtained when the mobile device switched to the cellular data network; and
the mobile device streaming voice data of the VoIP call using the cellular data network.

8. A method of Internet Protocol (IP) to IP handover, the method comprising:
a mobile device forming a cellular data connection to a Session Initiation Protocol (SIP) Proxy to connect to a cellular data network using Transmission Control Protocol (TCP);
registering the mobile device with an Internet Protocol Multimedia Subsystem (IMS) server using the SIP Proxy of the cellular data network;
the mobile device placing or receiving a Voice over IP (VoIP) call using the SIP Proxy;
the mobile device streaming voice data after the VoIP call is connected;
the mobile device dropping the cellular data connection to the SIP Proxy when a Wi-Fi™ network comes into range;
the mobile device establishing an IP connection using the Wi-Fi™ network;
the mobile device registering with the SIP Proxy server using the Wi-Fi™ network; and
the mobile device using a SIP REINVITE method to transfer the VoIP call to a new IP address obtained when the mobile device switched to the Wi-Fi™ network.

9. The method of claim 8 further comprising:
the mobile device dropping the IP connection to the SIP Proxy via the Wi-Fi™ network when a different Wi-Fi™ network comes into range;
the mobile device establishing an IP connection using the different Wi-Fi™ network;
the mobile device registering with the SIP Proxy server using the different Wi-Fi™ network; and
the mobile device using a SIP REINVITE method to transfer the VoIP call to a new IP address obtained when the mobile device switched to the different Wi-Fi™ network.

10. The method of claim 8 further comprising:
the mobile device dropping the IP connection to the SIP Proxy via the Wi-Fi™ network;
the mobile device establishing an IP connection using the cellular data network;
the mobile device registering with the SIP Proxy server using the cellular data network; and
the mobile device using a SIP REINVITE method to transfer the VoIP call to a new IP address obtained when the mobile device switched to the cellular data network.

11. A method of Internet Protocol (IP) to IP handover, the method comprising:
a mobile device forming a cellular data connection to a cellular data network;
registering the mobile device with an Internet Protocol Multimedia Subsystem (IMS) server using the cellular data network by means of Transmission Control Protocol (TCP) transport for Session Initiation Protocol (SIP) signaling;
the mobile device placing or receiving a Voice over IP (VoIP) call using the cellular data network;
the mobile device streaming voice data after the VoIP call is connected;
a Connection Manager of the mobile device signaling a Session Initiation Protocol (SIP) application of the mobile device that a Wi-Fi™ connection is available;
the mobile device establishing an IP connection using the Wi-Fi™ network while maintaining the cellular data connection to the cellular data network;
the mobile device registering with the IMS server using the Wi-Fi™ network;
the mobile device using a SIP REINVITE method to transfer the VoIP call to a first new IP address obtained when the mobile device switched to the Wi-Fi™ network; and
after the VoIP call is transferred to the first new IP address, the mobile device disconnecting from the cellular data network.

12. The method of claim 11 further comprising
a Connection Manager of the mobile device signaling a Session Initiation Protocol (SIP) application of the mobile device that a different Wi-Fi™ connection is available;
the mobile device establishing an IP connection using the different Wi-Fi™ network while maintaining the connection to the Wi-Fi™ network;
the mobile device registering with the IMS server using the different Wi-Fi™ network;
the mobile device using a SIP REINVITE method to transfer the VoIP call to a second new IP address obtained when the mobile device switched to different Wi-Fi™ network; and
after the VoIP call is transferred to the second new IP address, the mobile device disconnecting from the Wi-Fi™ network.

13. The method of claim 11 further comprising
a Connection Manager of the mobile device signaling a Session Initiation Protocol (SIP) application of the mobile device that the cellular data connection is available;
the mobile device establishing an IP connection using the cellular data network while maintaining the connection to the Wi-Fi™ network;
the mobile device registering with the IMS server using the cellular data network;
the mobile device using a SIP REINVITE method to transfer the VoIP call to a second new IP address obtained when the mobile device switched to the cellular data network; and
after the VoIP call is transferred to the second new IP address, the mobile device disconnecting from the Wi-Fi™ network.

14. A method of Internet Protocol (IP) to IP handover, the method comprising:
a Session Initiation Protocol (SIP) application of a mobile device connecting to a port of a virtual network on the mobile device;
a router on the mobile device routing registration of the mobile device with an IP Multimedia Core Network Subsystem (IMS) server from the virtual network to a cellular data network using Transmission Control Protocol (TCP);
the mobile device placing or receiving a Voice over IP (VoIP) call using the cellular data network;
the mobile device streaming voice data after the VoIP call is connected;
a Connection Manager of the mobile device disconnecting the mobile device from the cellular data network when a Wi-Fi™ network comes into range;
the Connection Manager of the mobile device establishing an IP connection to the Wi-Fi™ network; and
the router switching the VoIP call from the cellular data network to the Wi-Fi™ network.

15. The method of claim 14 further comprising:
a Connection Manager of the mobile device disconnecting the mobile device from the Wi-Fi™ network when a different Wi-Fi™ network becomes available;
the Connection Manager of the mobile device establishing an IP connection to the different Wi-Fi™ network; and
the router switching the VoIP call from the Wi-Fi™ network to the different Wi-Fi™ network.

16. The method of claim 14 further comprising:
a Connection Manager of the mobile device disconnecting the mobile device from the Wi-Fi™ network;
the Connection Manager of the mobile device establishing an IP connection to the cellular data network; and
the router switching the VoIP call from the Wi-Fi™ network to the cellular data network.
